(19) United States
(12) Patent Application Publication
(10) Pub. No.: US 2011/0295167 A1
(43) Pub. Date: Dec. 1, 2011

(54) APPARATUS FOR MUSCLE LOOSENING AND REHABILITATION

(76) Inventor: Georgette Suttman, Houston, TX (US)

(21) Appl. No.: 13/204,724

(22) Filed: Aug. 8, 2011

Related U.S. Application Data
(63) Continuation of application No. 12/653,580, filed on Dec. 16, 2009.

(51) Int. Cl. A61H 23/00

(52) U.S. Cl. 601/111

(57) ABSTRACT

Apparatuses for passive muscle loosening and rehabilitation are described. The apparatuses are assigned for patients who suffer from limited range of motion, stiffness, pain, inflammation, and dysfunction caused by muscles that have become tight, hard, stiff, and contracted due to over use, excessive exercise, repetitive motions, and a life time of usage, as well as other users who desire to keep their muscles loose. The operation principle of the apparatus is based on peg pressing during which pegs extend out of corresponding openings in the apparatus housing and put pressure on a desired part of human body, thereby providing muscle loosening in this part of human body. Different embodiments provide different ways of driving the pegs to extend out of the apparatus housing.

### CROSS-REFERENCE TO RELATED APPLICATIONS

This application claims priority of U.S. Non-Provisional application Ser. No. 12/653,580, entitled “Apparatus and Method for Loosening and Rehabilitating Muscles”, filed Dec. 16, 2009, which is incorporated herein by reference in its entirety for all purposes.

### TECHNICAL FIELD

The present disclosure relates generally to muscular health resumption, and more particularly to an apparatus which provides passive muscle loosening and rehabilitation.

### BACKGROUND

The approaches described in this section could be pursued but are not necessarily approaches that have been previously conceived or pursued. Therefore, unless otherwise indicated, it should not be assumed that any of the approaches described in this section qualify as prior art merely by virtue of their inclusion in this section.

Muscles become tight, hard, stiff, and contract due to over use, excessive exercise, repetitive motions, and a life time of usage. This results in limited range of motion, stiffness, pain, inflammation, and dysfunction.

Massage is a well known therapy to enhance healing process, promoting relaxation and well-being. Typically, massage involves acting on and manipulating the body with pressure (structured, unstructured, stationary, or moving) such that forces are distributed against upper layers of muscles to increase the flow of blood. However, it was shown that massage is not a good therapy in the process of loosening and rehabilitation of muscles damaged after surgeries, stresses, injuries, and etc., while it was demonstrated that pressing technique may help rehabilitate muscles more effectively.

Muscle rehabilitation for the above reasons and after injuries or operations with the help of pressing significantly increases general and local stimulation of muscles and tissues throughout a human body. Pressing technique may help improving these conditions, and rehabilitate tight muscles.

Nowadays, there are a lot of different devices providing passive rehabilitation for muscle restoration or softening. Typically, these devices require manual adjustment before starting an exercise session, and in some cases, during the exercise session.

Therefore, there is a need for providing a device capable of loosening and softening muscular tissue effectively in order to restore muscular health by means of physical manipulation of pressing by a mechanical device.

### SUMMARY

The following presents a simplified summary of one or more embodiments in order to provide a basic understanding to the reader of such embodiments. This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In accordance with one or more embodiments and the corresponding disclosure thereof, various aspects are described herein in connection with passive loosening and rehabilitation for muscular tissues.

According to one aspect, an apparatus for muscle loosening and rehabilitation is provided. The apparatus may comprise: a housing having one or more openings, at least one railing connected to the inner surface of the housing, a plurality of pegs connected to the at least one railing, at least one actuator configured to periodically move the at least one railing in one direction normal to the plane which a patient is lying or resting on, and a motor configured to drive the at least one actuator, wherein, when the at least one railing is driven by the at least one actuator, each of the plurality of pegs is configured to extend out of the one or more openings in the housing and put pressure on a desired muscle area.

According to yet another aspect, an apparatus for muscle loosening and rehabilitation is provided. The apparatus may comprise: a housing having one or more openings, a plurality of pegs, a plurality of actuators, each actuator of the plurality of actuators being configured to periodically move one of the plurality of pegs in one direction normal to the plane which a patient is lying or resting on, and a motor configured to drive each of the plurality of actuators, wherein, when the plurality of pegs is driven by the plurality of actuators, each of the plurality of pegs is configured to extend out of the one or more openings in the housing and put pressure on a desired muscle area.

According to yet another aspect, an apparatus for muscle loosening and rehabilitation is provided. The apparatus may comprise: a housing having a recess, one or more railings connected to the inner surface of the housing, a frame movably connected to the one or more railings, a plurality of peg sockets, each of the plurality of peg sockets having a peg inserted therein, driving means configured to move the frame within the housing, a plurality of actuators, each actuator of the plurality of actuators being configured to periodically move the peg in one of the plurality of peg sockets in one direction normal to the plane which a patient is lying or resting on, and one or more motors configured to drive the plurality of actuators, wherein, when the pegs in the plurality of peg sockets are driven by the plurality of actuators, the peg in each of the plurality of peg sockets is configured to extend out of the recess in the housing and put pressure on a desired muscle area.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

Embodiments are illustrated by way of example and not limitation in the figures of the accompanying drawings, in which like references indicate similar elements and in which:

FIG. 1 illustrates a perspective view of an apparatus for muscle loosening and rehabilitation according to an exemplary embodiment;

FIG. 2 illustrates is a cross section view of the apparatus shown in FIG. 1, according to an exemplary embodiment;

FIG. 3 illustrates is a cross section view of the apparatus shown in FIG. 1, according to another exemplary embodiment;

FIG. 4 illustrates an apparatus for muscle loosening and rehabilitation according to yet another exemplary embodiment;

FIG. 5 illustrates is a top view of the apparatus shown in FIG. 5, according to an exemplary embodiment.

FIG. 6 illustrates a perspective view of the for muscle loosening and rehabilitation, according to an example embodiment.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspects may be practiced without these specific details.

Aspects are disclosed in the following description and related drawings directed to specific embodiments. Alternate embodiments may be devised without departing from the disclosed scope. Additionally, well-known elements will not be described in detail or will be omitted so as not to obscure the relevant details.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The word “exemplary” is used herein to mean “serving as an example, instance, or illustration”. Any embodiment described herein as “exemplary” is not necessarily to be construed as preferred or advantageous over other embodiments. Likewise, the term “embodiments” does not require that all embodiments include the discussed feature, advantage or mode of operation.

According to one or more embodiments disclosed herein, an apparatus for muscle loosening or rehabilitation is provided. In one exemplary embodiment, such an apparatus is assigned to be used by patients suffering from muscle dysfunction caused by tightness and contraction due to over use, excessive exercise, repetitive motions, injury, surgery, and a life time of usage. Other embodiments imply the application of the apparatus by any other users who desire to keep their muscles in tonus. Muscle loosening or rehabilitation is performed with the help of “pressing” technique. In terms of this document, “pressing” refers to the technique of applying deep penetrating pressure to along the entire length of the muscle.

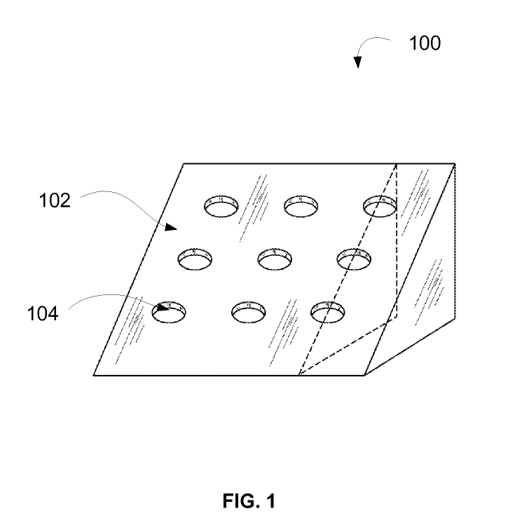

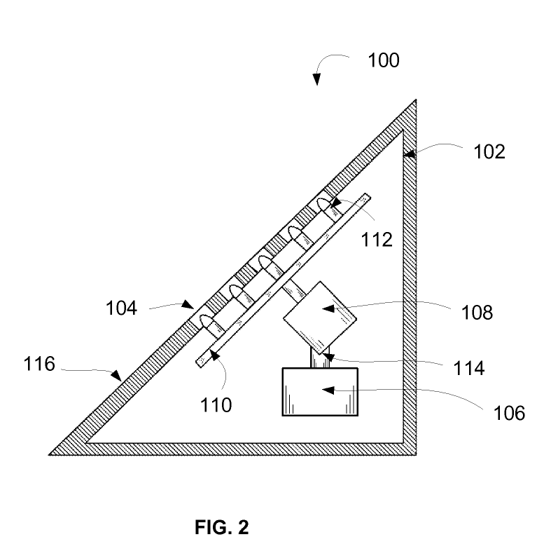

Referring now to the drawings, FIGS. 1-2 illustrate an exemplary apparatus 100 for muscle loosening and rehabilitation.

FIG. 1 illustrates a perspective view of the apparatus 100 for muscle loosening and rehabilitation. As shown, the apparatus 100 comprises a housing 102. The housing 102 is made in the form of a wedge and has a plurality of openings 104 which are separate from one another. The material of the housing 102 can comprise metal, synthetic materials (e.g., plastics, different polymers, etc.), semi-synthetic materials, wooden materials, or any combination thereof. The wedge-designed apparatus 100 is assigned to be used when a user desires to loosen muscles around patient neck, shoulders, and patient back. For this purpose, the apparatus 100 can be embedded into or put on a bed, a sofa, a hospital bed, etc.

Although, FIG. 1 shows that the housing 102 has a wedge design, alternatively it can be configured in the form of rectangular parallelepiped or the like. In some embodiments, the apparatus 100 may have design suitable for receiving separate parts of the user, such as feet, legs, etc.

In one embodiment, the housing 102 is made in the form of a tabletop. The tabletop-designed apparatus 100 is applied when the user desires to loosen muscles in patient legs and back. Similarly, in this case, the apparatus 100 can be embedded into or put on a bed, a sofa, a hospital bed, and so forth.

According to yet another embodiment, the housing 102 is made in the form of a chair. The chair-designed apparatus 100 can applied when the user desires to stimulate muscles under side of his/her legs and his/her back. In such a case, the apparatus 100 can be embedded into or put on chairs of different types.

Those skilled in the art would understand that the apparatus 100 can be differently shaped depending on an application.

Further, in some other embodiments, all or some of the plurality of openings 104 can be made as a whole, and in this case, they may represent one or more recesses in the housing 102.

FIG. 2 illustrates an exemplary interior of the apparatus 100 having the wedge design. This view is a sectional elevation performed such as shown in FIG. 1 (the dashed area).

As shown in FIG. 2, the interior of the apparatus 100 includes a motor 106, an actuator 108, a railing 110 and five pegs 112. The motor 106 is configured to drive the actuator 108. The actuator 108 is in turn configured to drive the railing 110 perpendicular to the surface (116) so that the pegs project from the outer surface. As shown, the railing 110 and the pegs 112 can be made as a whole. The motor 106 and the actuator 108 are coupled to each other with the aid of an energy transmission element 114. The element 114 can be made as a device consisting of a plurality of pinions, bearing and axes, or a rotation moment transformer with frequency increase or decrease, or any other device capable of transmitting mechanical or electrical energy.

As used herein, the term “motor” relates to a machine designed to convert energy of any type, e.g., heat energy, electrical energy, etc., into useful mechanical motion. In one embodiment, the motor 106 is an electric motor which takes electrical energy and generates mechanical motion via varying electromagnetic fields.

Furthermore, as referred hereinafter, the term “actuator” refers to a mechanical device for moving or controlling a mechanism or system. It can be operated by a source of energy, usually in the form of an electric current, fluid or pneumatic pressure, and converts that energy into some kind of motion. Mechanical actuators may operate by conversion of rotary motion into linear motion, or vice versa. Conversion can be made via a screw jack, ball screw, roller screw, hoist, winch, rack and pinion, chain drive, belt drive, rigid chain and rigid belt actuators operate on the principle of the wheel and axle, and the like. The actuator shown in FIG. 2 is a mechanical actuator which is driven by the motor 106.

In some other embodiments, the actuator 108 can be an electromagnetic engine, an electrostatic engine, an electric drive, a pneumatic drive or hydraulic drive. Those skilled in the art would understand that, in these cases, there is no need to use the motor 106, since such actuators are self-driven.

As also referred hereinafter, the term “peg” is a short piece of wood, metal, plastic, or any their combination, typically tapered at one end. The material of the pegs 112 can comprise metal, wood, rubber, resins, plastic resins, silicone rubber, elastomers, polymers, synthetic rubber, synthetic resins, synthetic materials, semi-synthetic materials, or any combination thereof.

In some embodiments, the tops of the pegs 112 are of an equal or different form. For instance, the base of the peg 112 can be made as a cylinder, a prism, a cube, a pyramid, etc., and the tops of the peg 112 can be rounded, pyramidal, canonical, or flat.

As referred hereinafter, the term “railing” is a structure made of rails and upright members that is used as a guard or barrier or for support. In one embodiment, the railing 110 is implemented as a profile element made of metal, synthetic materials, semi-synthetic materials, or other constructive materials.

Although, FIG. 2 illustrates only one motor 106, one actuator 108, one railing 110 and five pegs 112, those skilled in the art would understand that any number of the constructive elements can be used in the apparatus 100, depending on the application of the apparatus 100.

In one embodiment, the apparatus 100 can comprise multiple actuators 108, each driven by a separate motor 106. In such a case, the number of motors 106 may be equal to the number of actuators 108.

In one more embodiment, the number of the actuators 108 can be equal to the number of the railings 110. In this case, each actuator 108 can be configured to drive only one railing 110.

In another embodiment, the number of the actuators 108 and the number of the railings 110 can differ from each other. If the number of actuators 108 is less than the number of the railings 110, all or some of the actuators 108 can be configured to drive more than one railing 110, e.g., each actuator 108 can drive two railings 110. If the number of actuators 108 is more than the number of the railings 110, some of the actuators 108 can be in an off-state, while the other can drive the railings 110. In such a case, the off-state actuators 108 can be used as reserve actuators.

The operation principle of the apparatus 100 consists in the following. When the apparatus 100 is in an off-state, the pegs 112 are retracted within the housing 102. Once the apparatus 100 transits in an on-state, the motor 106 drives the actuator 108 to move the railing 110 with the pegs 112 in one direction normal to the plane the user is resting or lying on. In the shown example, such a plane is a facet 116. In these circumstances, when the railing 110 is driven by the actuator 108, each of the pegs 112 extends out of the corresponding opening 104 in the housing 102 and puts pressure on the user's body part which touches the facet 114.

In an embodiment, the actuator 108 can be configured to move the railing 110 with the pegs 112 in another direction parallel to the plane the user is resting or lying on. Such movement of the railing 110 can be used when the user desires to provide peg pressing to another part of his/her body. This movement of the railing 110 can be performed during peg pressing, i.e. without having to cease the operation of the apparatus 100.

In one other embodiment, the apparatus 100 can comprise multiple actuators 108 and multiple railings 110. In this case, the actuators 108 can drive the railings 112 synchronously or non-synchronously, which leads to the synchronous or non-synchronous extending of the pegs 112 out of the openings 104 in the housing 102, thereby providing different ways of muscle loosening.

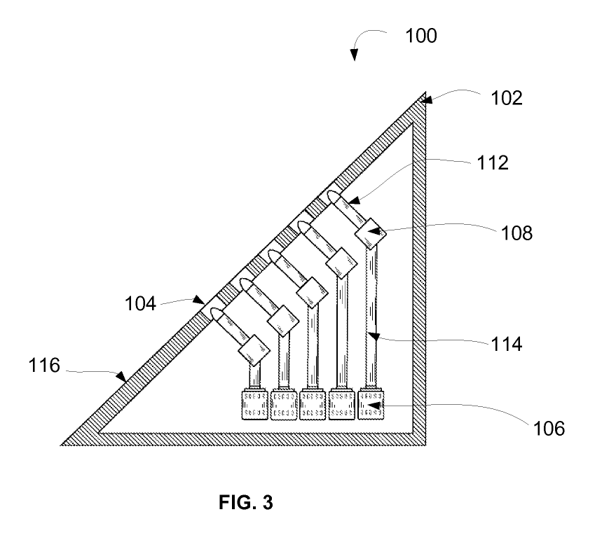

FIG. 3 illustrates another exemplary interior of the apparatus 100 for muscle loosening and rehabilitation. This view is a sectional elevation performed such as shown in FIG. 1 (the dashed area).

As shown in FIG. 3, the interior of the apparatus 100 includes five motors 106, five actuators 108 and five pegs 112. Each motor 106 is configured to drive a single actuator 108. Each actuator 108 is in turn configured to drive one of the pegs 112. The motors 106 and actuators 108 are coupled to each other with the aid of the energy transmission elements 114.

Although, FIG. 3 illustrates only five motors 106, five actuators 108 and five pegs 112, those skilled in the art would understand that any number of the constructive elements can be used in the apparatus 100.

In one embodiment, the apparatus 100 can be implemented such that all actuators 108 are driven by a single motor 106.

In one more embodiment, the number of the actuators 108 can be equal to the number of the pegs 112. In this case, each actuator 108 can be configured to drive only one peg 112.

In another embodiment, the number of the actuators 108 and the number of the pegs 112 can differ from each other. If the number of actuators 108 is less than the number of the pegs 112, all or some of the actuators 108 can be configured to drive more than one peg 112, e.g., each actuator 108 can drive two pegs 112. If the number of actuators 108 is more than the number of the pegs 112, some of the actuators 108 can be in an off-state, while the other can drive the pegs 112. In such a case, the off-state actuators 108 can be used as reserve actuators.

The operation principle of the apparatus 100 consists in the following. When the apparatus 100 is in an off-state, the pegs 112 are retracted within the housing 102. Once the apparatus 100 transits in an on-state the motor 106 drives the actuators 108 to move the pegs 112 in one direction normal to the plane the user is resting or lying on. In the shown example, such a plane is the facet 116. In these circumstances, when each of the pegs 112 is driven by one of the actuators 108, the each of the pegs 112 extends out of the corresponding opening 104 in the housing 102 and puts pressure on the user's body part which touches the facet 116.

In one embodiment, the actuators 108 can be configured to move the pegs 112 in the direction parallel to the plane 116 the user is resting or lying on. Such movement of the pegs 112 can be used when the user desires to provide peg pressing to another part of the body. This movement of the pegs 112 can be performed during peg pressing, i.e. without having to cease the operation of the apparatus 100.

In one embodiment, the actuators 108 can drive the pegs 112 to synchronously or non-synchronously extend out of the opening 104 in the housing 102, thereby providing different ways of muscle stimulation.

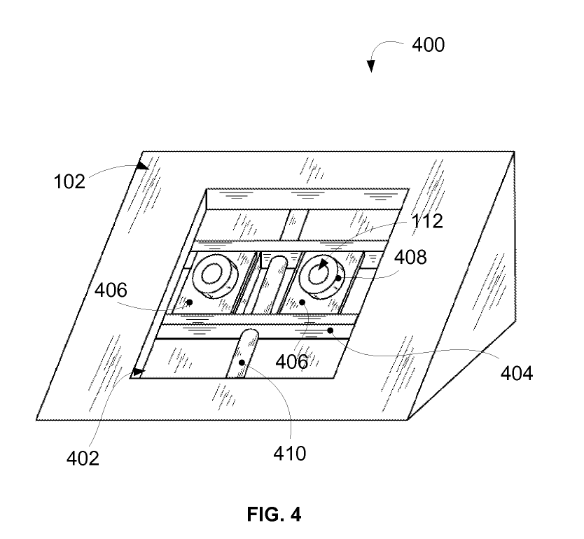

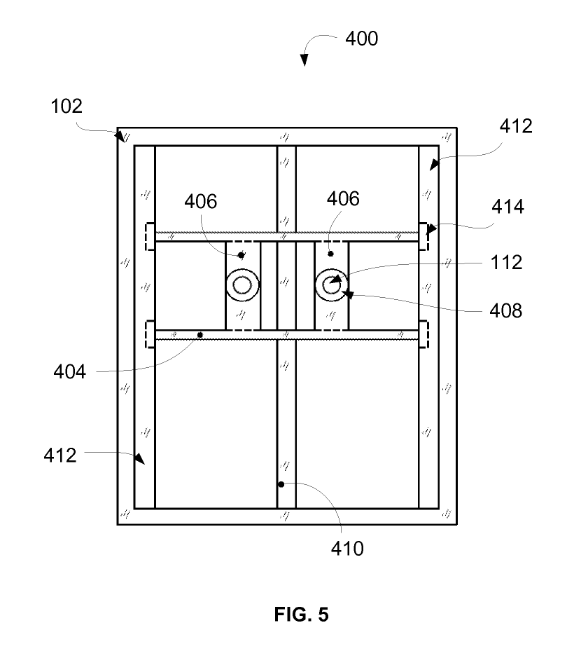

FIGS. 4 and 5 illustrate yet another exemplary apparatus 400 for muscle loosening and rehabilitation.

FIG. 4 illustrates the exterior of the apparatus 400, according to an example embodiment. As shown, the apparatus 400 comprises the housing 102. The housing 102 is made in the form of the wedge and has a recess 402. Although, in FIG. 4, the recess 402 is square-shaped, it should be clear that it has any other form, e.g., triangular, oval, diamond, etc.

Although, FIG. 4 shows that the housing 102 has a wedge design, alternatively it can be configured in the form of rectangular parallelepiped or the like. The wedge-designed apparatus 400 is assigned to be used when a user desires to stimulate loosen muscles around his/her neck, shoulders, and back. For this purpose, the apparatus 400 can be embedded into or put on a bed, a sofa, a hospital bed, etc. In some embodiments, the apparatus 400 may have design suitable for receiving separate parts of the user, such as feet, legs, etc.

FIG. 4 also illustrates some constructive elements embedded into the apparatus 400. As can be seen through the recess 402, the apparatus also comprises a movable frame 404 (which can moves up and down), two movable plates 406 (which can move left and right with the moveable frame 404), two peg sockets 408 with two pegs 112 inserted therein, and a drive mechanism 410. More detail description of the elements will be given below with reference to FIG. 5.

FIG. 5 illustrates the interior of the apparatus 400 having the wedge design, according to an example embodiment. More specifically, this figure is a view of the apparatus 400 without that facet which comprises the recess 402.

As shown in FIG. 5, the interior of the apparatus 400 includes the moveable frame 404 having two movable plates 406, two peg sockets 408 each mounted on a separate plate 406, the drive mechanism 410 configured to move the frame 404 up and down, and two railings 412 attached to the inner surface of the housing 102. The housing 102 may be made of a number of interconnected railings, plates, braces, panels, etc. attached thereto. Each peg socket 408 comprises the peg 112 retracted within it and the actuator 108 (not shown) mounted on its bottom butt. The peg sockets 408 can have different forms, e.g. cylindrical, cubic, prismatic, etc., depending on particular designs of the apparatus 400.

The drive mechanism 410 can be implemented as a screw drive, which in turn can be connected to a drive gear (not shown) which provides rotation of the screw drive about its axis. In some embodiments, the drive mechanism 410 is any profile element made of metal, plastic or other constructive elements. In some embodiments, the drive mechanism 410 can be implemented as a screw drive. It should be noted that the apparatus 400 may have one drive mechanism 410 or more, e.g. two screw drives 410 arranged in parallel to each other. The apparatus 400 may have not the drive mechanism 410 at all.

According to yet another embodiments, the drive mechanism 410 can be differently implemented and possess gears, pinions, gear wheels, chains, movable strips, and other elements. In one example, the drive mechanism 410 may have an electric motor attached to one or more rollers 414.

In general, the drive mechanism 410 is configured to move the frame 404 within the housing 102 in the vertical direction. Those skilled in the art would appreciate that multiple possibilities exist to provide the possibility to move the frame 404 within the housing 102.

Similarly, the plates 406 are configured to move in horizontal direction with the frame 404. Any suitable driving mechanism can be used to move them together or separately (e.g. an electric motor can be used along with pinions, gear, etc.). In some embodiments, such plates 406 can be fixed on the frame 404.

Each of the actuators 108 may be connected by the energy transmission elements 114 (not shown) to the motor 106 (not shown) which drives it. Alternatively, actuators 108 may be directly connected to corresponding motors 106.

In one embodiment, the apparatus 400 is implemented such that each of the actuators 108 is driven by a separate motor 106. In this case, the number of motors 106 is equal to the number of actuators 108. This number is two in the shown embodiment.

As referred hereinafter, the term “frame” is used to describe any structure supporting different elements thereon. In exemplary embodiments, the frame 404 is any profile element made of metal, plastic or other constructive materials. The frame 404 can have different forms, depending on particular designs and application of the apparatus 400.

As referred hereinafter, the term “socket” relates to a structure with a hollow where any apparatus constructive element can be inserted. In the present disclosure, such an element is the peg 112. In some embodiments, the socket 408 is any profile element made of metal, plastic or other constructive elements.

The operation principle of the apparatus 400 consists in the following. When the apparatus 400 is in an off-state, each of the pegs 112 is inside the peg socket 408. Once the apparatus 400 begins working, the motor 106 (not shown) drives the actuators 108 (not shown) which in turn drive the pegs 112 in the peg sockets 408 to extend out of the peg sockets 408 from the recess 402 and put pressure on a desired muscle area. The part of user's body subjected to peg pressing can be changed by moving the frame 404 and/or plates 406. The frame 404 is configured to move up and down along the screw drive 410, depending on whether the screw drive 410 performs clockwise or counter-clockwise rotation about its axis. During the screw drive rotation, the frame 404 is also guided by the railings 412. In one embodiment, the frame 404 can be provided with two or more rollers 310 which allow the frame 404 to go on the railings 412. Simultaneously, plates 406 may move left and right within the frame 404.

Thus, peg pressing can be performed in different parts of user's body, when the frame 404 and/or plates 406 move in vertical and/or horizontal directions, accordingly.

In some other embodiments, the pegs 112 can extend out of the peg sockets 408 synchronously or non-synchronously, thereby providing different ways of muscle stimulation.

In some other embodiments, the actuators 108 can drive the peg sockets 408 on the surface of frame 404 in the direction perpendicular to the railings 412. Such movement can be performed during peg pressing and/or the movement of the frame 404. The peg socket 408 can also move to and from synchronously or asynchronously.

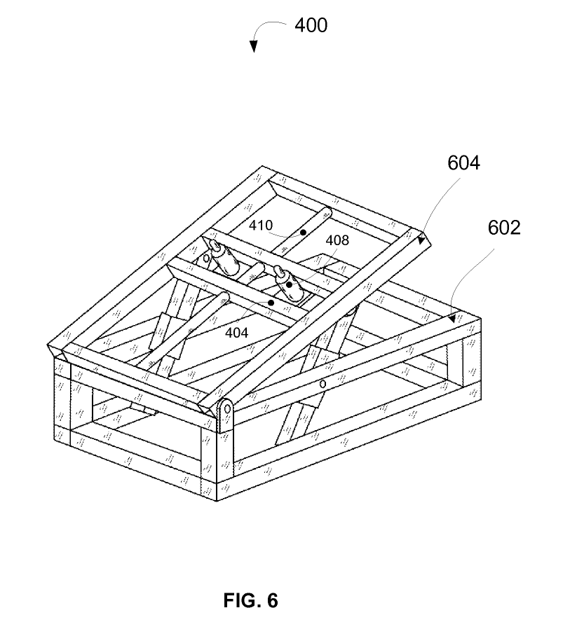

FIG. 6 illustrates a perspective view of the apparatus 400 for muscle loosening and rehabilitation, according to an example embodiment. Specifically, FIG. 6 shows the diagram of the apparatus framework.

According to the shown example, the framework may comprise a main part 602 having the square-like form, and an additional movable frame 604. The additional frame 604 is pivotally connected to the main frame 602. Both elements can be provided with mechanics to recline the additional frame 604. Such mechanics may include one or more electrical motors, hydraulic actuators, railings, pinions, bearings, sliders, stoppers, and so forth. Those who are skilled in the art would understand that many possible designs are possible to provide ability to pivotally recline the frame 604 against the main frame 602.

The embodiment shown in FIG. 6 may extend functionality of the apparatus 400 by making it more flexible to adjustable for different purposes. For example, when the frame 604 rests on the main frame 602, the apparatus 400 for muscle loosening and rehabilitation can be used as a part of table or bed such that patients may need to lie up on it. Alternatively, when the frame 604 is reclined, the apparatus 400 can be used by patients in a sitting position.

Each of shown exemplary apparatuses 100 and 400 disclosed above can be further provided with infrared, ultrasonic, ionic, heating or cooling devices. Such devices are assigned to improve muscle loosening. In particular, the infrared devices emit infrared rays which may heat any part of the user's body in order to relax muscles. This relaxation may lead to a greater effect from peg pressing and, consequently, better muscle loosening. As for the ultrasonic devices, they generate ultrasonic waves which can change muscle blood flow, which also results in better muscle stimulation by pegs. The ionic devices use safe, painless, low-level, waveform-shaped currents (electrical impulses) to “reprogram” muscles to nearly original muscle shape. The gentle electrical impulses facilitate rehabilitation of muscles and improve blood circulation. The heating and cooling devices are applied to heat and cool muscles before or during peg pressing. The infrared, ultrasonic, ionic, heating or cooling devices can be mounted on different constructive elements of the apparatuses 100, 400, e.g., on the tops of the pegs 112.

Furthermore, each of the discussed apparatuses 100, 400 for muscle loosening and rehabilitation can be provided with electronic devices, e.g. microcontrollers, processors, microprocessors, programmable logic devices, a computer, a processing unit, etc. Such electronic devices can be used to control the speed of peg pressing, the duration of peg pressing and the mode of peg pressing. In addition, the apparatuses may be provided with am input device, and a display. All these electronic devices can be part of the apparatus 100, 400 or can be implemented as separate devices which are coupled to the apparatuses 100, 400.

Those skilled in the art would also appreciate that different treating programs can be used. Such treating programs may involve different frequency of pressing, different moving patterns, directions, different forces, etc. The treating methodics may also include locking one or more pegs in the extended position.

In some embodiments, the apparatuses 100, 400 can be covered with softening materials, e.g., any kinds of fabric, leather, synthetic materials, etc., to soften the peg influence on the user's body. According to one more embodiments, the apparatuses 100, 400 can be also provided with any elastic element on the surface with the openings 104 or the recess 402 so as to provide additional comfort to the user resting or lying on this surface.

In some other embodiments, the apparatuses 100, 400 can be provided with additional accessories, such as an adjustable headrest/face cradle, a round head bolster, a half round head bolster, two side/arm extensions, two leg extensions, and so forth. These accessories can be part of the housing 102, or can be implemented as separate elements attachable to the housing 102. The accessories are assigned to provide more comfort to the user during peg pressing.

Thus, the apparatus for muscle loosening and rehabilitation has been described. The apparatus provides passive muscle loosening by means of peg pressing. The apparatus is assigned to be used by patients who suffer from muscle dysfunction that results in limited range of motion, stiffness, pain, inflammation, and dysfunction. and any other users who desire keep their muscles healthy.

Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. An apparatus for muscle loosening and rehabilitation, comprising:
a housing having one or more openings;
at least one railing connected to the inner surface of the housing;
a plurality of pegs connected to the at least one railing;
at least one actuator configured to periodically move the at least one railing in one direction normal to the plane which a patient is lying or resting on; and
wherein, when the at least one railing is driven by the at least one actuator, each of the plurality of pegs is configured to extend out of the one or more openings in the housing and put pressure on a desired muscle area.

2. The apparatus of claim 1, further comprising one or more motors, the one or more motors being configured to drive the at least one actuator.

3. The apparatus of claim 1, wherein the at least one actuator is further configured to periodically move the at least one railing in another direction parallel to the plane which the patient is lying or resting on.

4. The apparatus of claim 1, wherein each of the at least one railing is driven by corresponding one of the at least one actuator.

5. The apparatus of claim 1, wherein the at least one actuator is a mechanical actuator, an electromagnetic engine, an electrostatic engine, an electric drive, a pneumatic drive or hydraulic drive.

6. The apparatus of claim 1, further comprising one or more of an infrared device, an ultrasonic device, an ionic device, a heating device, and a cooling device.

7. An apparatus for muscle loosening and rehabilitation, comprising:
a housing having one or more openings;
a plurality of pegs; and
a plurality of actuators, each actuator of the plurality of actuators being configured to periodically move one of the plurality of pegs in one direction normal to the plane which a patient is lying or resting on;
wherein, when the plurality of pegs is driven by the plurality of actuators, each of the plurality of pegs is configured to extend out of the one or more openings in the housing and put pressure on a desired muscle area.

8. The apparatus of claim 7, further comprising one or more motors, the one or more motors being configured to drive the at least one actuator.

9. The apparatus of claim 7, wherein the plurality of actuators is further configured to periodically move the plurality of pegs in another direction parallel to the plane which the patient is lying or resting on.

10. The apparatus of claim 7, wherein each of the plurality of actuators is a mechanical actuator, an electromagnetic engine, an electrostatic engine, an electric drive, a pneumatic drive or hydraulic drive.

11. The apparatus of claim 7, further comprising one or more of an infrared device, an ultrasonic device, an ionic device, a heating device, and a cooling device.

12. An apparatus for muscle loosening and rehabilitation, comprising:
a housing having a recess;
one or more railings connected to the inner surface of the housing;
a frame movably connected to the one or more railings, a plurality of peg sockets, each of the plurality of peg sockets having a peg inserted therein;
driving means configured to move the frame within the housing;
a plurality of actuators, each actuator of the plurality of actuators being configured to periodically move the peg in one of the plurality of peg sockets in one direction normal to the plane which a patient is lying or resting on; and
one or more motors configured to drive the plurality of actuators;
wherein, when the pegs in the plurality of peg sockets are driven by the plurality of actuators, the peg in each of the plurality of peg sockets is configured to extend out of the recess in the housing and put pressure on a desired muscle area.

13. The apparatus of claim 12, wherein the driving means comprises one or more of:
a screw drive connected to the housing and the frame;
a driving gear configured to periodically rotate the screw drive; and
wherein, when the driving gear rotates the screw drive, the frame is configured to move along the screw drive.

14. The apparatus of claim 12, wherein the frame further comprises one or more movable plates, and wherein the plurality of peg sockets is arranged on the or more movable plates, and wherein one or more movable plates being configured to move within the frame.

15. The apparatus of claim 12, wherein the plurality of actuators is further configured to periodically move the pegs in the plurality of peg sockets in another direction parallel to the plane which the patient is lying or resting on.

16. The apparatus of claim 12, wherein the plurality of peg sockets are arranged on one or more plates movable in the direction parallel to the plane which the patient is lying or resting on.

17. The apparatus of claim 12, wherein the peg in each of the plurality of peg sockets moves synchronously or asynchronously with the peg in another of the plurality of peg sockets.

18. The apparatus of claim 12, wherein each of the plurality of actuators is a mechanical actuator, an electromagnetic engine, an electrostatic engine, an electric drive, a pneumatic drive or hydraulic drive.

19. The apparatus of claim 13, wherein the driving gear is an electric, hydraulic or pneumatic gear.

20. The apparatus of claim 12, further comprising one or more of an infrared device, an ultrasonic device, an ionic device, a heating device, and a cooling device.
